(19) United States
(12) Patent Application Publication
(10) Pub. No.: US 2009/0278420 A1
(43) Pub. Date: Nov. 12, 2009

(54) MEMS-BASED NANOPOSITIONERS AND NANOMANIPULATORS

(76) Inventors: Yu Sun, Toronto (CA); Xinyu Liu, Toronto (CA)

Correspondence Address: MILLER THOMPSON, LLP, Scotia Plaza, 40 King Street West, Suite 5800, TORONTO, ON, M5H 3S1, CA

(21) Appl. No.: 12/305,478

(22) PCT Filed: Jun. 21, 2007
(86) PCT No.: PCT/CA2007/001092

§ 371 Date: Dec. 18, 2008

(30) Foreign Application Priority Data
Jun. 23, 2006 (CA) 2,551,194

(51) Int. Cl. H02N 1/00

(52) U.S. Cl. 310/308

(57) ABSTRACT

A MEMS-based mano manipulator or nanopositioner is provided that can achieve both sub-nanometer resolution and millimeter force output. The nanomanipulator or nanopositioner comprises a linear amplification mechanism that minifies input displacements and amplifies input forces, microactuators that drive the amplification mechanism to generate forward and backward motion, and position sensors that measure the input displacement of the amplification mechanism. The position sensors obtain position feedback enabling precise closed-loop control during nanomanipulation.

### PRIORITY

This application claims the benefit of Canadian Patent No. 2,551,194, filed 23 Jun. 2006.

### FIELD OF THE INVENTION

The present invention relates to nanotechnology and nanoscience and engineering.

### BACKGROUND OF THE INVENTION

Microelectromechanical Systems (“MEMS”) refers to technology on a very small scale, and converges at the nano-level into nanoelectromechanical systems (“NEMS”) and nanotechnology, although NEMS can also refer to nano devices employing nano-scaled materials as active elements.

Recent advances in nanoscience and nanotechnology, including the manipulation and characterization of nano-materials (e.g., carbon nanotubes, silicon nanowires, and zinc oxide nanorods) and NEMS development, require manipulators with a nanometer positioning resolution, micrometer motion range, high repeatability, and large force output (i.e. payload driving capability). At present, the most common nanomanipulator used for precise positioning and manipulation inside SEM (scanning electron microscope) or TEM (transmission electron microscope) utilizes piezoelectric actuators.

Many other attempts have been made to construct devices using MEMS technologies. Electrostatic microactuators are most commonly used for nanopositioning. A comb drive microactuator with capacitive position sensor has been presented, which can provide a positioning resolution of 10 nm. (See P. Cheung and R. Horowitz, “Design, fabrication, position sensing, and control of an electrostatically-driven polysilicon microactuator,” IEEE Trans. Magnetics, Vol. 32, pp. 122-128, 1996.) However, the application of this device is limited by its sub-micronewton force output. Resolution and positioning capability of the devices are sacrificed when driving a load.

Electrothermal microactuators were also employed in the development of nanopositioners. A dual-stage (coarse-motion stage and fine-motion stage) nanopositioner actuated by electrothermal actuators has been disclosed. (N. B. Hubbard, L. L. Howell, “Design and characterization of a dual-stage, thermally actuated nanopositioner,” J. of Micromechanics and Microengineering, Vol. 15, No. 8, pp. 1482-1493, 2005.)

Further, a thermally actuated stage with a resolution of 30 nm for mechanical properties testing of nano-materials has been reported. (S. N. Lu, D. A. Dikin, S. L. Zhang, F. T. Fisher, J. Lee, and R. S. Ruoff, “Realization of nanoscale resolution with a micromachined thermally actuated testing stage,” Review of Scientific Instruments, Vol. 5, No. 6, pp. 2154-2162, 2004.) Although electrothermal microactuation provides much larger output forces, hysteresis and thermal drift make the positioning accuracy relative low (tens to hundreds of nanometers) in open-loop operations. Furthermore, the difficulty of well controlled temperatures at the probe tip prevents its use in temperature sensitive applications.

U.S. Pat. No. 6,874,668 teaches utilizing a nanomanipulation system to telescope a multiwalled nanotube. The patent provides no information on nanomanipulators themselves, although it provides a specific application where nanomanipulators are needed.

U.S. Pat. No. 6,805,390 discloses the use of two carbon nanotubes and electrostatics to form a pair of nanotweezers for grasping nano-scaled objects. The nanotweezers will be mounted on a nanomanipulator for positioning/moving the nanotweezers, which is another specific application where nanomanipulators are needed.

U.S. Pat. No. 5,903,085 relates to the use of piezoelectric actuators for nanopositioning. The positioning stage is not a micro device; rather, it is a macro system. Piezoelectric actuator-based systems typically provide a motion resolution of 1 nm. However, inherent hysteresis and creep of piezoelectric actuators result in significant open-loop positioning errors, and therefore, demand sophisticated compensation control algorithms.

U.S. Pat. No. 6,967,335 discloses a nanomanipulation system using piezoelectric actuators for use in SEM or TEM. Besides the high cost, the large sizes of commercially available piezoelectric nanomanipulators (5 cm to 20 cm) limit their use when applications have stringent space constraints. Although this system can be installed inside an SEM, it is too large to fit in the chamber of a TEM. It is a macro-scaled system having 5 nm motion resolution, which is different from our invention of MEMS-based nanomanipulators (millimeter by millimeter in size, sub-nanometer motion resolution).

In sum, known piezoelectric stages can achieve a positioning resolution of 1 nm. However, inherent hysteresis and creep of piezoelectric actuators result in significant open-loop positioning errors, and therefore, demand sophisticated compensation control algorithms. Besides the high cost, the large sizes of commercially available piezoelectric nanomanipulators (5 cm to 10 cm) limit their use when applications have stringent space constraints, particularly inside TEMs.

Although MEMS-based nanomanipulators have such advantages as low cost, small size, fast response, and flexibility for system integration, existing MEMS devices (e.g., electrostatic actuators and electrothermal actuators) are not capable of achieving both high positioning resolution and large force output.

What is needed are novel MEMS-based nanomanipulators with sub-nanometer resolution and millinewton force output, overcoming the aforementioned limitations of existing MEMS devices.

### SUMMARY OF THE INVENTION

In one aspect of the present invention, a MEMS-based nanomanipulator is provided which can achieve both sub-nanometer resolution and millimeter force output.

In another aspect of the present invention, an integrated displacement sensor is provided to obtain position feedback that will enable precise closed-loop control during nanomanipulation and nanopositioning.

In an embodiment of the present invention, a nanomanipulator leverages the high repeatability and fast response of MEMS electrostatic microactuators while overcoming the limitation of low output forces. The device integrates a highly linear amplification mechanism, a lateral comb-drive microactuator, and a capacitive position sensor. The amplification mechanism is used to minify input displacements provided by the comb-drive microactuator for achieving a high positioning resolution at the output probe tip and to amplify output forces for manipulating nano-objects. The capacitive position sensor is placed at the input end as a position encoder to measure the input displacement. The strict linearity of the amplification mechanism guarantees that the position sensor can provide precise position feedback of the output probe tip, allowing for closed-loop controlled nanomanipulation.

### BRIEF DESCRIPTION OF THE DRAWINGS

A detailed description of one or more embodiments is provided herein below by way of example only and with reference to the following drawings, in which:

FIG. 1 illustrates a one degree-of-freedom nanomanipulator.

FIG. 2 is a cross sectional view of the nanomanipulator according to FIG. 1 along axis A-A.

FIG. 3 is a schematic diagram of the linear amplification mechanism with single axis flexure hinge pivots.

FIG. 4 is a schematic diagram of the linear amplification mechanism with flexible beam pivots.

FIG. 5 illustrates a two degree-of-freedom nanomanipulator built by orthogonally connecting two one degree-of-freedom nanomanipulators.

FIG. 6 illustrates a nanomanipulator integrating a two-stage lever mechanism.

FIG. 7 is a schematic diagram of the two-stage lever mechanism with single axis flexure hinge pivots.

FIG. 8 is a schematic diagram of the two-stage lever mechanism with flexible beam pivots.

FIG. 9 illustrates a nanomanipulator integrating a differential triplate capacitive position sensor.

In the drawings, one or more embodiments of the present invention are illustrated by way of example. It is to be expressly understood that the description and drawings are only for the purpose of illustration and as an aid to understanding, and are not intended as a definition of the limits of the present invention.

### DETAILED DESCRIPTION OF THE INVENTION

The present invention provides a MEMS-based nanomanipulator which can achieve both sub-nanometer resolution and millimeter force output. An integrated displacement sensor is also provided to obtain position feedback that enables precise closed-loop control during nanomanipulation.

It should be expressly understood that the present invention functions either as a nanomanipulator or as a nanopositioner. As a nanomanipulator, besides the applications described herein, the device can be applied to precisely interacting with biological molecules, such as for biophysical property characterization or precisely picking and placing nano-sized objects, such as nanotubes/wires and nano particles. As a nanopositioner, the device can find a range of precision applications for in-plane positioning, for example, as an x-y precision positioner that can be mounted on the suspension head of a computer harddrive for data transfer. Currently, a meso-scaled piezoelectric positioner is used on the suspension head of a harddrive. The relatively long-term goal of the harddrive industry is to achieve a 0.01 nm positioning resolution. This ultra-high resolution is within the capability of the present invention that also offers the advantage of low cost, closed-loop operation, and high reproducibility across devices.

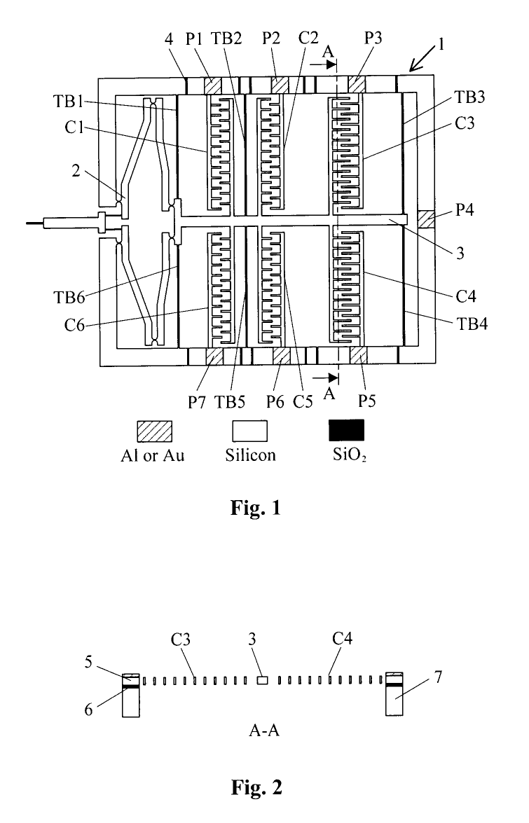

In an embodiment of the present invention, a nanomanipulator comprises three main parts, as illustrated in FIG. 1 and FIG. 2: (i) a linear amplification mechanism 2 that minifies or reduces input displacements and amplifies or increases input forces; (ii) lateral comb-drive microactuators C1, C2, C5, C6 that drive the amplification mechanism to generate forward and backward motion; and (iii) capacitive position sensors C3, C4 that measure the input displacement of the amplification mechanism. The capacitive position sensor can be connected with the input end through a shaft 3, for example.

Comb-drive microactuators are commonly used components in MEMS research, and their design is well known. In the context of the present invention, the comb-drive microactuators have fast response, but low force output. The amplification mechanism 2 is employed in a minification mode to provide the microactuators C1, C2, C5, and C6 a low input stiffness to generate a large input displacement, which is minified to a nano-scaled displacement at the output end 9 (FIG. 3). By changing the input stiffness of the amplification mechanism 2 and the stiffness of the tethering beams TB1, TB2, . . . , TB6 at the input end, the resolution and motion range of the nanomanipulator can be adjusted.

The total electrostatic force Fₑ generated by the comb-drive microactuators is

$${F}_{e} = \frac{1}{2} \frac{{N}_{a} ɛ {h}_{a}}{{g}_{a}} {V}^{2}$$

where ε is the permittivity of air, V the actuation voltage, h_{α} the finger thickness, g_{α} the gap between adjacent actuation comb fingers, and N_{α} is the number of actuation comb finger pairs. Therefore, the output displacement yₒᵤₜ of the nanomanipulator is

$${y}_{out} = \pm \frac{α}{{K}_{sum}} = \pm \frac{1}{2} \frac{α}{{K}_{sum}} \frac{{N}_{a} ɛ {h}_{a}}{{g}_{a}} {V}^{2}$$

where α is the minification ratio of the amplification mechanism, and Kₛᵤₘ the input stiffness of the nanomanipulator.

To measure the input displacement and obtain the output displacement, the capacitance changes of the electrode pairs C4, C5 are measured. The capacitance change ΔC of the capacitive sensor is

$$Δ C = \frac{{N}_{s} ɛ {h}_{s}}{{g}_{s}} {y}_{in}$$

where Nₛ is the number of sensing comb finger pairs, hₛ the sensing finger thickness, gₛ the gap between adjacent sensing comb fingers, and yᵢₙ the input displacement. The output displacement can also be accurately predicted via

$${y}_{out} = α {y}_{in} = \frac{α {g}^{′}}{{N}_{s} ɛ {h}_{f}^{′}} Δ C$$

The devices are preferably constructed by DRIE (deep reactive ion etching) on SOI (silicon on insulator) wafers that provide accurate control of device thickness and the convenience of mechanical connection and electrical insulation. (These microfabrication processes are known; see, e.g., Yu Sun, S. N. Fry, D. P. Potassek, D. J. Bell, and B. J. Nelson, “Characterizing fruit fly flight behavior using a microforce sensor with a new comb drive configuration,” IEEE/ASME Journal of Microelectromechanical Systems, Vol. 14, No. 1, pp. 4-11, 2005). Electrical insulation between groups of actuation and sensing comb-drives is achieved by etching gaps 4 into device silicon layer 5 (FIG. 2) and stopping at the buried silicon dioxide layer 6.

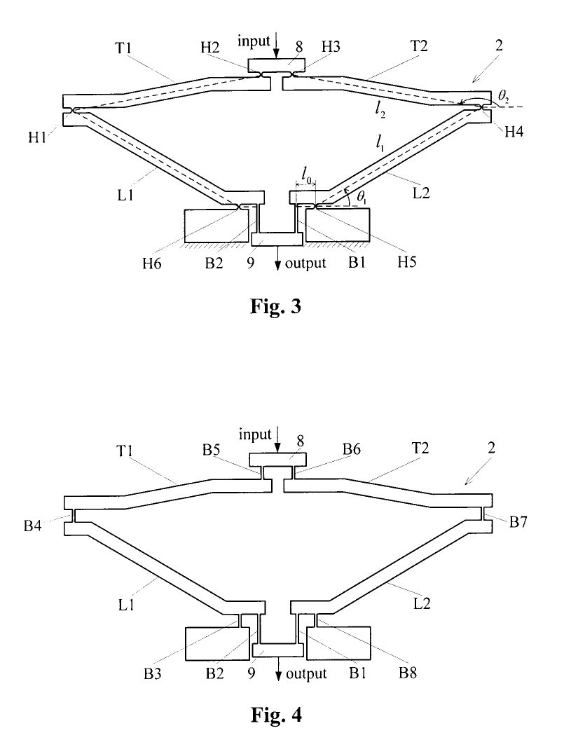

FIG. 3 and FIG. 4 show the structural detail of the linear amplification mechanism. The mechanism integrates two typical amplification mechanisms: toggle mechanism T1, T2 and lever mechanism L1, L2, which are connected in series by flexible pivots. The pivots can be either single-axis flexure hinges H1, H2, . . . , H6 in FIG. 3, or flexible beams B3, B4, . . . , B8 in FIG. 4. The input displacement is minified by the toggle mechanism first, and then, the lever mechanism decreases the motion further. In order to eliminate lateral displacements at the output end caused by lever rotation, two pairs of toggle mechanisms T1, T2 and lever mechanisms L1, L2 are symmetrically configured. Flexible beams B1, B2 connect the two output ends of the lever mechanisms with the output platform 9. The minification ratio of the amplification mechanism is

$$α = \frac{{y}_{out}}{{y}_{in}} = - \frac{{l}_{0}}{{l}_{1} ( cos {θ}_{1} - sin {θ}_{1} cot {θ}_{2} )}$$

where l₀ and l₁ are the lengths of lever short beam and long beam, l₂ the length of toggle beam, θ₁ and θ₂ the rotational angles of lever long beam and toggle beam. The input stiffness of the amplification mechanism is

$${K}_{sum} = \frac{2 α}{{l}_{0} {l}_{1} cos {θ}_{1}} \{ \begin{matrix}- \frac{{l}_{1}}{{l}_{2}} {K}_{hinge} [ \begin{matrix}cos ( {θ}_{1} + {θ}_{2} ) + \\ sin {θ}_{1} cos {θ}_{2} cot {θ}_{2}\end{matrix} ] - \\ 2 {K}_{hinge} - \frac{E {wh}^{3}}{12 l}\end{matrix} \} + \frac{4 {EW}_{1} {H}_{1}^{3}}{{L}_{1}^{3}} + \frac{2 {EW}_{2} {H}_{2}^{3}}{{L}_{2}^{3}}$$

where K_{hinge} is the torsional stiffness of the single axis flexure hinge, E the Young's modulus of silicon, w, h, and l the width, height, and length of the flexible beams B1, B2; W₁, H₁, and L₁ the width, height, and length of the flexible beams TB2, TB3, TB4, and TB5; and W₂, H₂, and L₂ the width, height, and length of the flexible beams TB1, TB6.

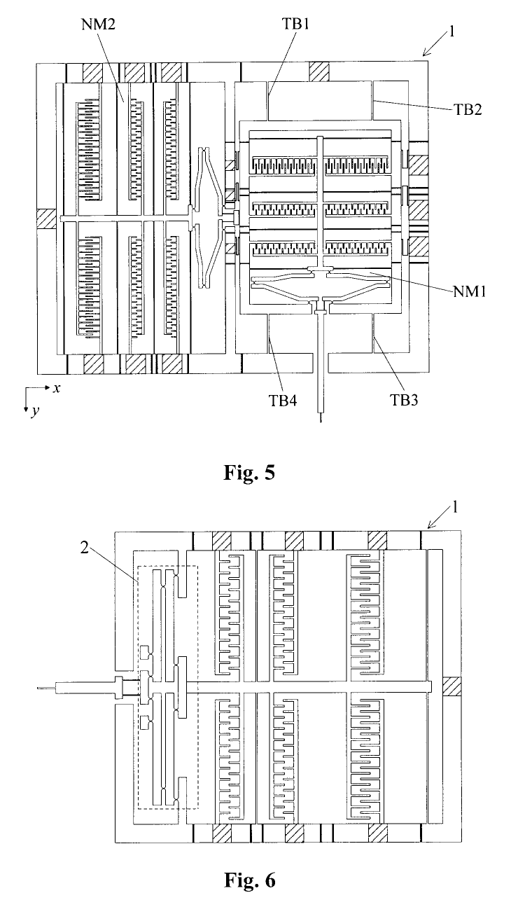

A two-degree-of-freedom nanomanipulator, for example, can be constructed by orthogonally connecting two one-degree-of-freedom nanomanipulators NM1, NM2, as shown in FIG. 5. NM2, responsible for driving the probe tip along the x direction, is suspended by four tethering beams TB1, TB2, TB3, and TB4. NM2 drives NM1 to generate motion along they direction.

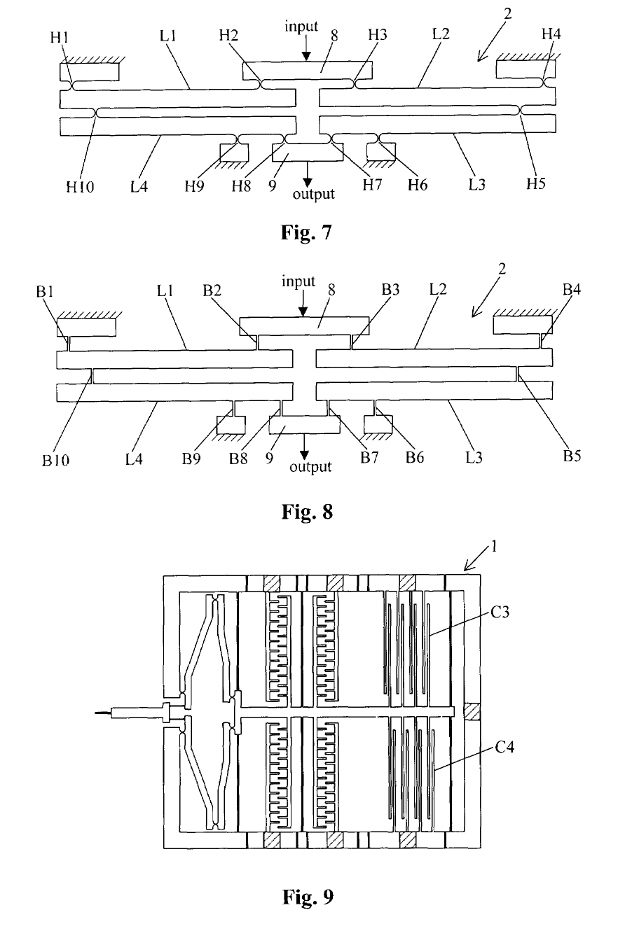

The nanomanipulator can also adopt other amplification mechanisms to implement the minification of input displacements and amplification of output force. FIG. 6 illustrates a nanomanipulator integrating a two-stage lever mechanism 2, the configuration of which is shown in FIG. 7 and FIG. 8. Two lever mechanisms L1, L4, input end 8, and output end 9 are connected by flexible pivots, which can be either single axis flexure hinges H1, H2, H8, and H9 in FIG. 7, or flexible beams B1, B2, B8, and B9 in FIG. 8. The input displacement is minified twice by L1 and L4. A similar symmetric configuration eliminates the lateral displacement of the output end caused by lever rotation.

Position sensing can utilize either lateral comb drives or differential traverse comb drives to achieve linearity and a higher resolution than lateral comb drives. As shown in FIG. 9, a differential tri-plate comb structure C3, C4, suitable for bulk micromachining, has a higher sensitivity than lateral comb position sensor (C3, C4 in FIG. 1), and therefore, improves the motion resolution of the nanomanipulator further.

Although the use of lateral comb-drive microactuators was described in the example above, other embodiments of the present invention are possible. For example, although electrothermal microactuators have a generally poorer repeatability than comb-drive microactuators, with the integrated position sensors of the present invention it is possible to perform closed-loop positioning, which will compensate for the poorer repeatability of electrothermal microactuators. Consequently, due to the integrated position sensors permitting closed-loop positioning, electrothermal microactuators can be implemented instead of comb-drive electrostatic microactuators in an alternative embodiment of the present invention.

It should also be understood that a further design aspect of the present invention includes a coarse-fine actuation mechanism. Described above is a nanomanipulator/nanopositioner that is capable of producing a total motion of a few micrometers. By integrating these devices with another electrostatic or electrothermal microactuator as an outer-loop for coarse positioning, the devices will have an operating range of tens of micrometers while still offering the same sub-nanometer motion resolution.

Further, extension of the present x-y in-plane nanopositioner to an x-y-z three-dimensional nanopositioning device (e.g., via microassembly), even broader applications are possible, such as for atomic force microscopy (AFM) scanning, optical coherence microscopy (OCM), and phase-shifting interferometry.

In sum, the MEMS nanomanipulators of present invention possess the following advantages: (i) sub-nanometer motion resolution; (ii) millinewton force output; (iii) permitting closed-loop controlled nanomanipulation; (iv) fast response; (v) low cost due to wafer-level microfabrication; and (vi) small size.

It will be appreciated by those skilled in the art that other variations of the one or more embodiments described herein are possible and may be practised without departing from the scope of the present invention.

What is claimed is:

1. A device for manipulating or positioning objects, characterised in that the device comprises:
(a) an amplification mechanism; and
(b) a microactuator connected with an input end of the amplification mechanism;
wherein the amplification mechanism minifies input displacement and amplifies input force; and
wherein the microactuator drives the input end forward and backward along an axis thereby causing an output end to move forward and backward along the axis.

2. The device of claim 1 further characterised in that a capacitive position sensor is connected with the input end.

3. The device of claim 2 further characterised in that the capacitive position sensor measures forward and backward input displacements of the amplification mechanism thereby predicting an output displacement of the amplification mechanism.

4. The device of claim 2 further characterised in that the capacitive position sensor is a lateral comb-drive position sensor or a differential traverse comb-drive position sensor.

5. The device of claim 2 further characterised in that the microactuator is a comb-drive electrostatic microactuator or an electrothermal microactuator.

6. The device of claim 1 further characterised in that the amplification mechanism comprises symmetrically-configured toggle mechanisms and lever mechanisms.

7. The device of claim 1 further characterised in that the amplification mechanism comprises a pair of toggle mechanisms and a pair of lever mechanisms, the toggle mechanisms and the lever mechanisms symmetrically configured.

8. The device of claim 7 further characterised in that the toggle mechanisms and the lever mechanisms are flexibly connected.

9. The device of claim 8 further characterised in that the toggle mechanisms and the lever mechanisms are connected by single axis flexure hinges or flexible beams.

10. The device of claim 6 further characterised in that the lever mechanisms are connected to the output end by flexible beams.

11. The device of claim 1 characterised by a movement resolution of less than 1 nm.

12. The device of claim 1 characterised in that it is integrated with a second microactuator to define a coarse-fine actuation mechanism, the second microactuator acting as an outer loop for coarse positioning.

13. A tandem device for manipulating or positioning objections, the tandem device characterised in that it comprises a first nanomanipulator and a second nanomanipulator, the first nanomanipulator and the second nanomanipulator each comprising an amplification mechanism and a microactuator connected with an input end of the amplification mechanism, wherein the first nanomanipulator and the second nanomanipulator are arranged in substantially orthogonal positions.

14. The tandem device of claim 13 further characterised in that it is operable to produce in-plane motion along two directions.

15. The tandem device of claim 13 further characterised in that the first nanomanipulator or the second nanomanipulator is supported by tethering beams.
